(19) United States
(12) Patent Application Publication
(10) Pub. No.: US 2023/0191171 A1
(43) Pub. Date: Jun. 22, 2023

(54) PROTECTION FACE MASK UNIT WITH AN ADDITIONAL FILTER FOR THE EXHALED AIR

(71) Applicant: GVS S.P.A., Zola Predosa(BO) (IT)

(72) Inventors: Ben IRVING, Lancashire (GB); Ben HARTROPP, Cumbria (GB); Andrew CALLAND, Cumbria (GB)

(21) Appl. No.: 18/085,799

(22) Filed: Dec. 21, 2022

(30) Foreign Application Priority Data
Dec. 22, 2021 (IT) 102021000032183

(51) Int. Cl. A62B 23/02; A62B 18/02; A62B 18/10

(52) U.S. Cl. CPC A62B 23/025; A62B 18/025; A62B 18/10

(57) ABSTRACT

A face mask unit for protection against contaminants, for example in particles, comprises a face mask with a body having lateral inhalation filters inserted in seats of this body, the body cooperating with hooking means for fastening to a support element for supporting the mask on the face, and an exhalation valve for the exhaled air. An additional filtering member is provided, which is adapted to be arranged on the mask and bearing at least one filtering element, said additional filtering member being fixed to the mask and being arranged a short distance from it so as to create a space between the body of the mask and the filtering element, this space allowing air to flow in to the lateral inhalation filters unimpeded and also creating a void for the exhaled air from the exhalation valve to flow into before passing through said filtering element.

### RELATED APPLICATIONS

This application claims priority to Italian Patent Application No. 102021000032183, filed Dec. 22, 2021, the entire contents of which is incorporated herein by reference in its entirety.

### FIELD

The present disclosure relates to a face mask unit for protection against particulate contaminants, such as toxic dust particles and dangerous liquid and solid particles, metal fumes, nebulizing particles and microorganisms, for example bacteria or viruses or a mask for protection against gas and particulate matter.

### BACKGROUND

As is known, a face mask is designed to protect a user against particulate contaminants (toxic dust particles and dangerous liquid and solid particles, metal fumes, nebulizing particles and microorganisms, for example bacteria or viruses) and gaseous contaminants and particulate matter.

The protective masks mentioned above are generally of two types, i.e. masks that cover only half of the user's face (half-face masks) and leave the eyes free, or masks that completely cover this face, including the user's eyes (full face masks or half-face masks with goggles). They comprise a structure or body adapted to be positioned on the user's face; the body of the mask has yielding edges that rest on this face and make a seal on it. There is a support element for the mask, usually defined by straps adapted to keep the mask fixed on the user's face, whatever movement he/she may make. Both the half-face mask and the full face mask comprise at least one central non-return valve, with a diaphragm, for exhalation by the user and at least one or two side valves, covered by an inhalation filter, for air suction by the aforementioned user.

On the side valves there are corresponding grill elements which are constrained to the body of the mask and protect the respective filters.

Such a mask entrusts only to the central non-return valve, with diaphragm, the passage of the air exhaled by the user. This solution, however, does not allow any pathogenic viruses or microorganisms in the exhaled air to be retained by the aforementioned central valve as its primary function to allow the exhaled air to freely leave the mask and stop inhaled air bypassing the inhalation filter. By allowing the exhaled air to exit with minimal resistance, this prevents excessive moisture and build up within the mask.

The presence of a filter at the central valve could have a negative effect as to the accumulation of moisture within the mask, making it difficult to use, and in any case, it would have a very small filtering surface.

### BRIEF SUMMARY

An object of the present disclosure is to provide a mask unit comprising a protection face mask of the type mentioned above, but which also has the function of filtering the air exhaled by the user through the central valve so as to protect third parties from any dangerous pathogens present in the breath exhaled by that user of the mask.

Another object of the disclosure is to provide a mask unit of the aforementioned type wherein the filtration of the exhaled air does not involve an increase in humidity inside the mask, allowing it to be used without problems by the user, especially if the mask is full face type.

A further object of the present disclosure is to provide a mask unit of the aforementioned type which allows to always have an optimal filtration of the air sucked in by the user.

These and other objects which will be evident to the person skilled in the art are achieved by a mask unit according to the appended claims.

### BRIEF DESCRIPTION OF THE DRAWINGS

For a better understanding of the present disclosure, the following drawings are attached purely by way of non-limiting example, in which:

FIG. 1 is an exploded side perspective view of a mask unit according to the disclosure;

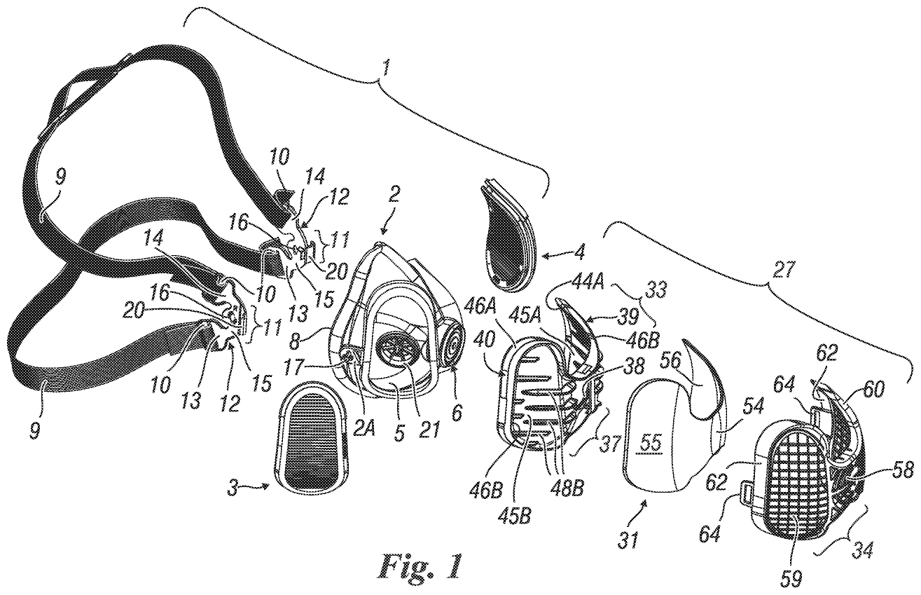

FIG. 2 is a perspective view from another angle of the mask unit of FIG. 1, partially assembled;

FIG. 3 is an exploded perspective view, from the same angle as FIG. 1, of the partially assembled mask unit;

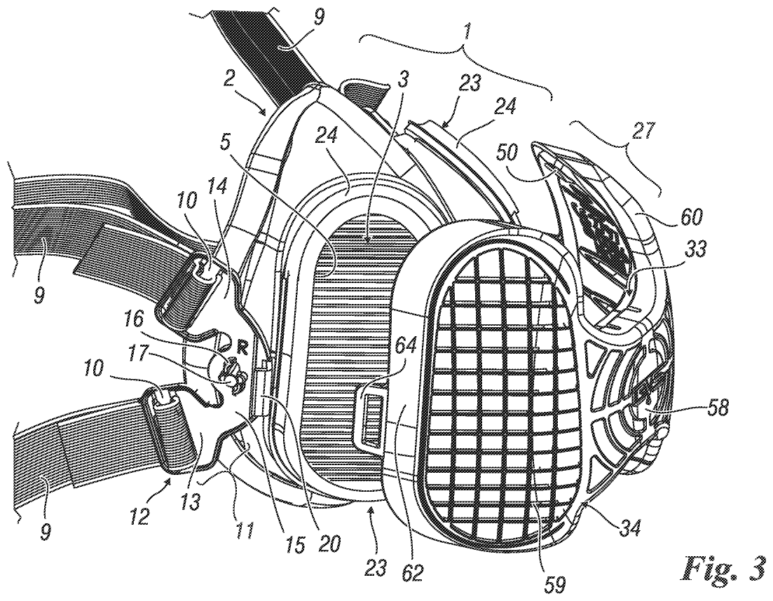

FIG. 4 is a partial close-up top perspective view of the mask unit according to the disclosure; and

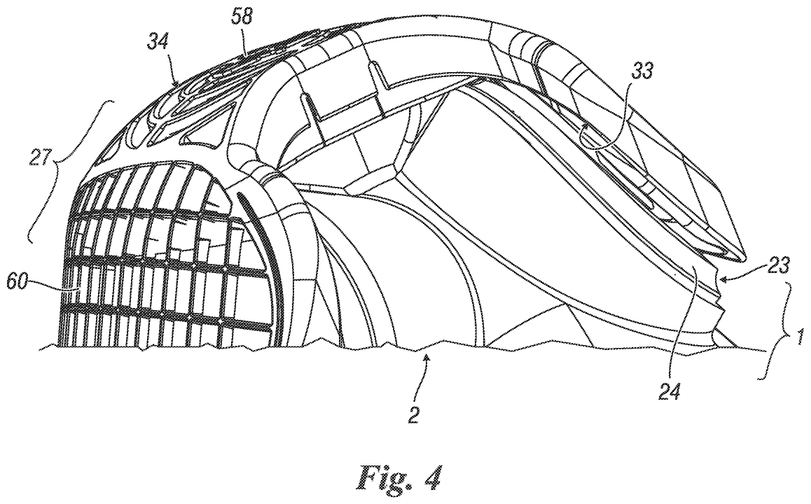

FIG. 5 shows a cross-sectional view, on a plane orthogonal to one of its longitudinal axes, of the mask unit of FIG. 1.

### DETAILED DESCRIPTION

With reference to the aforementioned figures, they show a mask unit comprising a face mask. This face mask is generically indicated with 1 and is of the “half-face” type. The disclosure, however, is also applicable to a “full face” or “half-face with goggle” type mask.

The mask 1 comprises a body 2 having lateral inhalation filters (3, 4, for example with activated carbon), placed in seats 5 of the body 2.

The body 2 of the mask 1 also comprises a central exhalation valve 6 (known per se) and an edge 8 having a yielding surface adapted to rest on the user's face so as to seal it when the mask is worn.

Usual straps 9 fasten the body 2 of the mask to the aforementioned face; these straps are connected to adjustment buckles 10 placed on both sides 2A of the body 2 of the mask and to which corresponding hooking means 11 are associated, each having a plate-like body 12 with arms 13 and 14 projecting from a central portion 15 and bearing the buckles 10. The central portion 15 has a hole 16 adapted to cooperate, in a per se known way, with a corresponding shaped pin 17, also known, projecting from each side 2A of the body 2.

The central portion 15 of the hooking means 11 also has an end hook 20.

In the seats 5 for the filters 3 and 4 usual valve elements 21 are provided.

The seats for the filters 3 and 4 have an edge 23 protruding from the corresponding side 2A of the body 2 of the mask, said edge having a 24 which is an arched surface in cross section.

An additional filtering member 27 is arranged at the central valve 6 and the sides 2A of the body 2, adapted to be firmly coupled (or fixed) to the mask 1 and to be arranged at a minimum distance therefrom. Said additional filtering member 27 is however independent from the face mask 1 such as an attachment or accessory of the mask.

Inside the filtering member 27 there is a channel or space 30 only for the passage of the air exhaled by a user who wears the mask through the central valve 6, so as to direct this exhaled air through a filter 31 associated with said additional filtering member 27 before it leaves the mask unit (defined by the mask 1 and this member 27). The exhalation valve 6 opens in channel or space 30.

More particularly, the additional filtering member 27 covers both the lateral inhalation filters 3, 4 and the central exhalation valve 6. Said member 27 has (starting from the mask 1) a sandwich structure which is independent from the face mask 1 and that can be connected to said mask. The sandwich structure comprises a rear plate 33 adapted to be placed in proximity to the mask 1, the filter 31 and a grill element 34, the filter being arranged between and held by said rear plate 33 and grid element 34 (which instead is present outside the mask unit). The filter 31 is located over the lateral inhalation filters 3, 4 and the central exhalation valve 6.

More in particular, the rear plate 33 has a body 37 having a central part 38 and side parts 39 and 40: the central part 38 has a hole 41 adapted to accommodate the central valve 6 on which the rear plate 33 rests by means of projections 43 projecting from an edge 44 of the aforementioned hole 41. The hole 41 clips on the exhalation valve 6 and the edge 44 seals against the mask body 2 around the exhalation valve 6. Projections 43 rest on the valve 6 front face to keep the rear plate 33 concentric to the valve 6.

The side parts 39 and 40, on the other hand, are adapted to overlap the seats 5 of the body 2 of the mask for filters 3 and 4 (and to the filters themselves). In this way, the rear plate 33 (which is in a single piece) covers the mask from side to side.

Each side part has opposite walls 45A and 45B, which are respectively internal (i.e. facing the corresponding seat 5 of the body 2 of the mask) and external. These walls are delimited by respective (internal and external) protruding edges 46A and 46B which define cavities in which there are ribs 48A, 48B rising from the walls 45A and 45B. The ribs 48A of the inner wall 45A of each side part 39 and 40 cooperate with the corresponding filter 3 and 4 but allow to maintain a space or channel between each filter and the corresponding 45A internal wall, the function of which will be described later.

Furthermore, projections 50 protrude from the internal protruding edge 46A in diametrically opposed positions adapted to cooperate with the arched surface 24 of the edge 23 of the seat 5 for the filter 3 and 4 which faces the corresponding side part 39 and 40.

This cooperation makes it possible to maintain the aforementioned space or channel between the filters 3 and 4 and the side parts 39 and 40 of the body 37 of the rear plate 33.

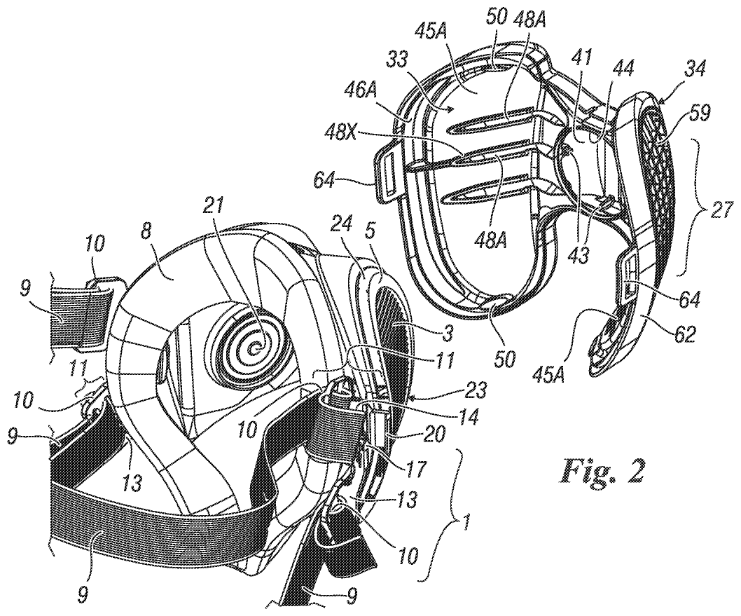

Preferably, a further rib 48X (see FIG. 2) also extends on the internal protruding edge 46A of each side part 39 and 40 so as to cooperate with the edge 23 of the respective seat 5 and maintain the distance between the internal wall 45A and the corresponding filter.

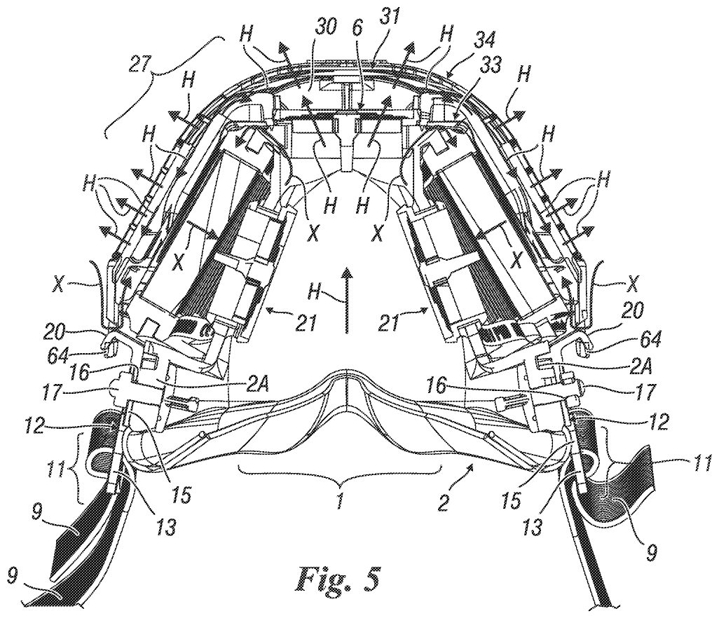

Even these projections 50 and the rib 48X make it possible to create the aforementioned channel, open both at a lower part of the mask (with reference to its use) and in the proximity to the hooking means 11, through which an inflow of the outer air is obtained inside the seats 5 (and the relative filters 3 and 4) for the correct breathing by the user wearing the mask. This inflow is indicated by the arrows X in FIG. 5.

The filter 31 of any known type (for example an electrostatic media) is a soft fabric pad (which, in the example, is in a single piece) that forms to the shape of the rear pate 37 when the additional filtering member 27 is coupled to the mask 1; therefore it comprises a central part 54 (solid, without hole), and side parts 55 and 56. Therefore, the filter 31 is located in correspondence to both the lateral inhalation filters 3, 4, and to the exhalation valve 6 which directly opens in space or channel 30.

This single piece filter is adapted to be sandwiched on the rear plate by the grill element 34 also having a conformation similar to that of the rear plate 37 (and therefore with a central part 58 and side parts 59 and 60, all grilled). It should be noted that the ribs 48B of the outer wall 45B of each side part 39 and 40 of the rear plate keep the filter 31 separate from the aforesaid plate, creating the space or channel 30 inside the additional filtering member 27. These ribs have a height (i.e. they space apart from the wall 45b) such as to maintain the filter 31 also distant from the opening of the hole 41 of the rear plate 33 (that is from the valve 6) so as to allow the air exhaled by the user wearing the mask 1 to enter into channel or space 30, move towards the outer walls 45B of the side parts 39 and 40 and exit from the grill element 34 through any part 58, 59 or 60 thereof, passing through the filter 31 through any part 54, 55 and 56.

This is shown by the arrows H in FIG. 5.

It should be noted that the grill element has an end edge 62 which, in addition to the filter 31, also contains the edges 46A of the rear plate 37 closing the space or channel 30 on its edges. Moreover the grill element 34 has side end eyelets 64 on the end edge 62 adapted to cooperate with the end hooks 20 of the hooking means 11 associated with the buckles 10 of the mask 1. This cooperation makes a sandwich compaction of and closes on each other the components 31, 33 and 34 of the additional filter member 27 and constrains said filter member to the mask 1. It should be noted however that the additional filtering member may be detached from the face mask 1 while this latter retains its functionality.

Thanks to the mask unit described, a low breathing resistance of the user wearing the mask 1 and, at the same time, a high filtering efficiency are obtained. This is due to the maximized filtering area offered by the filter 31 which is hit by the exhaled air over its entire surface due to the circulation of this air (which leaves the valve 6 of the mask 1) in the space or channel 30 between the rear plate 37 and the filter itself. At the same time, the dimensions of the mask 1 are substantially maintained and optimal use of the mask itself is allowed thanks to the flow of the aspirated air which reaches the suction or inhalation filters present on the sides of the mask in an unrestricted manner.

It should be noted that the user's breathing resistance is kept at low levels, contained thanks to the channel that is formed between the internal wall 45A of the rear plate 37 and the mask 1 which are determined, that is formed by the ribs 48 and 48X and by the ridges 50. This allows a circulation of air entering the mask to be always present regardless of any possible distortion during its use.

Thanks to the solution described, it is possible to adequately filter the air exhaled by the user wearing the mask, protecting third parties from any pathogens present therein. This is achieved without affecting the user's normal respiratory activity and without creating moisture inside the valve.

Summing up, the disclosure relates to a face mask unit comprising a face mask 1 suitable to be located on a user face, and an additional filtering element 27 suitable to be located over the face mask and to be fixed on it. The additional filtering element 27 is adopted to filter the exhaled air by the user before it reaches the environment. The additional filtering element 27 has an inner channel 30 which receives the user exhaled air from the central exhalation valve 6 of the face mask 1; in the same time, the filtering element comprises members (ribs 48A, 48X and projections 50) which permit to keep the additional filtering element 27 separate from the face mask 1 so to allow the air necessary to the user breathing to pass through the mask lateral inhalation filters 3, 4 (which are covered by the element 27).

A preferred embodiment of the disclosure has been described. Still others embodiments are possible: for example, the ribs 48A, 48B and the projections 50 of the rear plate 33 can be replaced by pins or other protrusions acting as means spacing the aforementioned rear plate of the mask and of the filter from the plate to create the channel of the air inflow in mask 1 and the air outflow from the mask. Alternatively, the filter element 31 can be defined by several side by side and/or superimposed bodies; or, again, the additional filtering member 27 can be constrained to hook-like elements directly integral to the mask 1 and cooperating with the grill element 34. These solutions also fall within the scope of the disclosure which is defined by the content of the claims.

1. A mask unit comprising a face mask for protection against particulate contaminants, the face mask having at least one exhalation valve, said face mask having a body having lateral inhalation filters inserted in corresponding seats, the body of the mask cooperating with hooking means for fastening to a support element for supporting the face mask on a user's the face, said mask unit being provided with an additional filtering member adapted to filter the air exhaled by the user emitted by the exhalation valve, wherein said additional filtering member is an independent element from the face mask and is arranged on and fixed to the front and the sides of the face mask above the lateral inhalation filters, said additional filtering member having spacer members suitable to keep said additional filtering member separated from the face mask so to permit the passage of air directed to said lateral inhalation filters, said additional filtering member comprising a sandwich structure having a filter enclosed between a grill element and a rear plate adapted to accommodate the exhalation valve of the mask, inside said sandwich structure a space or channel being defined wherein the exhalation valve opens and which receives the exhaled air which exits from the face mask through said exhalation valve, between said filter and the rear plate said space or channel being defined so to permit the circulation of the exhaled air coming from the exhalation valve which is distributed along the entire surface of the filter of the additional filtering member and that exits from the additional filtering member through the grill element.

2. The mask unit according to claim 1, wherein spacer means are provided to keep the filter separated from the rear plate and to create the space or channel for the passage of exhaled air at the exit from the exhalation valve.

3. The mask unit according to claim 2, wherein said spacer means are ribs provided on an external wall of the rear plate and protruding from said wall.

4. The mask unit according to claim 3, wherein said ribs have a height such as to keep the filter distant from the exhalation valve received by the rear plate.

5. The mask unit according to claim 1, wherein the exhalation valve is inserted in a hole of the rear plate.

6. The mask unit according to claim 1, wherein said spacer members are ribs projecting from an inner wall of lateral parts of the rear plate suitable to overlap the lateral inhalation filters of the face mask, and projections extending on internal protruding edges of said lateral parts delimiting the inner walls of the lateral parts, said spacer members being adapted to keep said rear plate spaced apart from the mask and create one or more channels for the inflow of air adapted to penetrate into the mask through the lateral filters on which the rear plate of the additional filtering member overlaps.

7. The mask unit according to claim 1, wherein the additional filtering member comprises fastening means for fastening to the mask and which allow at the same time to close the sandwich structure of this additional filtering member.

8. The mask unit according to claim 7, wherein said fastening means cooperate with said hooking means.

9. The mask unit according to claim 8, wherein said fastening means are side end eyelets associated with an end edge of the grill element and adapted to cooperate with end hooks of the hooking means.

10. The mask unit according to claim 6, wherein:
said rear plate comprises a body having a central part which houses the exhalation valve and side parts;
said filter comprises a central part and side parts;
said grill element comprises a central part and side parts all provided with a grid structure, and wherein said side parts of said rear plate, of the filter and of the grill element overlapping the lateral inhalation filters of the mask.

11. The mask unit according to claim 9, wherein said space or channel for the exhaled air present between said filter and the rear plate is closed on its sides by the end edge of the grill element and by said rear plate, the exhaled air being able to leave said space or channel only through said filter.
